(19) United States
(12) Patent Application Publication
(10) Pub. No.: US 2004/0125922 A1
(43) Pub. Date: Jul. 1, 2004

(54) Communications device with sound masking system

(76) Inventor: Jeffrey L. Specht, Wyoming, MI (US)

Correspondence Address: GENERAL NUMBER 00757, BRINKS HOFER GILSON & LIONE, P.O. BOX 10395, CHICAGO, IL, 60610, US

(21) Appl. No.: 10/659,754

(22) Filed: Sep. 10, 2003

Related U.S. Application Data
(60) Provisional application No. 60/410,669, filed on Sep. 12, 2002.

(51) Int. Cl. H04R 3/02; H04M 1/64; G10L 11/00

(52) U.S. Cl. 379/88.01; 381/73.1; 704/270

(57) ABSTRACT

A system and method for masking the voice of a user to provide privacy while the user is speaking. The system includes an audio input device that captures the voice sounds of a user. A masking signal generator is adapted to generate a masking signal that is at least partially derived from the voice sounds. One or more speakers are provided in order to emitting the masking signal. The system is particularly suited for use by persons seeking privacy while speaking on telephone.

### RELATED APPLICATIONS

The present patent document claims the benefit of the filing date under 35 U.S.C. §119(e) of Provisional U.S. Patent Application Serial No. 60/410,669, filed Sep. 12, 2002, which is hereby incorporated by reference.

### FIELD OF THE INVENTION

The present invention relates to a system and method for providing an external sound masking capability to the user of a communications device. Most particularly, the present invention relates to a system and method for generating a masking signal derived in part from the voice of a user of the communications device.

### BACKGROUND OF THE INVENTION

Occupational research has shown that privacy is a major issue for people who work in modular workspace systems, especially in open office environments. The issue of privacy has two components visual and sound. The major issue of sound privacy is the ability to speak without others overhearing what is being said. This is especially true when workers are talking on the telephone. The issue of sound privacy is particularly important when workers are present in relatively open work spaces. Also, the issue of sound privacy is important for those talking on wireless telephones in public places. In most cases, the ability to talk privately on the phone is only assured in specially designed spaces. However, even when a location appears to be fully enclosed, there are often pathways for sound to leak out and allow others to overhear the conversation. In those facilities where a secure sound enclosure exists, they are often limited in availability and not easily accessible for unanticipated private conversations.

Prior attempts to provide sound privacy have included systems for the generation of environmental white noise. While these systems have been effective in providing a masking sound, there continues to be a need for further methods and systems that provide efficient and effective sound privacy.

### SUMMARY OF THE INVENTION

In accordance with the present invention, a communications device and a voice masking system are disclosed that provides the user with a high degree of speech privacy while speaking.

A communications device with a sound masking system is provided. The communications device includes an audio input device adapted to capture the voice sounds of a user. A voice masking signal generator is in communication with the audio input device. The voice masking signal generator is adapted to generate a masking signal capable of interfering with the ability of others in the area of the communications device to readily discern the voice sounds of the user. The voice masking signal is at least partially derived from the voice sounds. At least one speaker is in communication with the masking signal generator in order to emit the voice masking signal.

A communications device with a voice masking system is provided. The communications device includes an audio input device adapted to receive and transmit the voice sounds of a user. A voice masking system generates and emits an audible voice masking signal. The audible voice masking signal is based on the voice of a user as detected by the audio input device. The voice masking signal is adapted to prevent others in the area of the user from readily discerning the voice sounds of the user. At least one speaker for emitting the voice making signal is provided.

A method for masking the voice of a user of a work environment is also provided. The method includes the step of capturing voice sounds of a user with an audio input device. A voice masking signal is derived at least in part from the captured voice sounds. The masking signal is capable of interfering with the ability of other users to readily discern the voice sounds of the user. A masking signal is emitted into at least a portion of the work environment.

As used herein, the term “communications device” is intended to be interpreted broadly so as to include at least cell phones, wired and wireless telephones and radios and other known communications devices.

Other aspects of the invention will become apparent to those skilled in the art in view of the description that follows.

### BRIEF DESCRIPTION OF THE DRAWINGS

FIG. 1A is perspective view of a workspace environment having a communications device and sound masking system in accordance with a first embodiment of the present invention.

FIG. 1B is a perspective view of another workspace environment having a communications device and sound masking system in accordance with a second embodiment of the present invention.

FIG. 2A is a perspective view of a communications device and sound masking system for use with a personal communications device in accordance with a third embodiment of the present invention.

FIG. 2B is a perspective view of an alternate embodiment of the personal communications device of FIG. 2A in accordance with a fourth embodiment of the present invention.

FIG. 3 is a schematic view illustrating the components of the voice masking system in accordance with an embodiment of the invention.

FIG. 4 is a schematic view illustrating the components of the voice masking system in accordance with another embodiment of the invention.

FIG. 5 is a flowchart illustrating a method of masking voice sounds in accordance with an embodiment of the present invention.

### DETAILED DESCRIPTION OF THE PREFERRED EMBODIMENTS

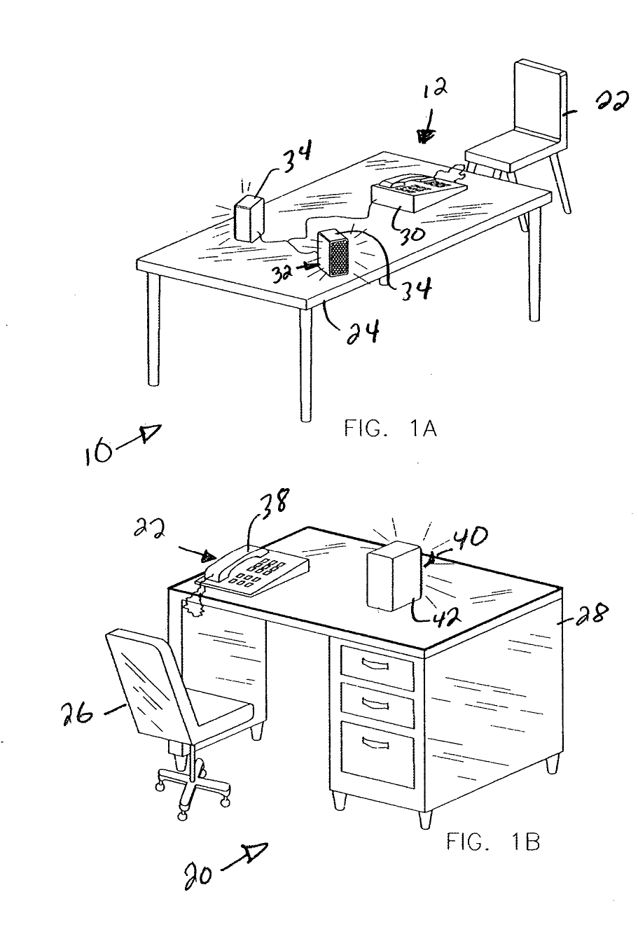

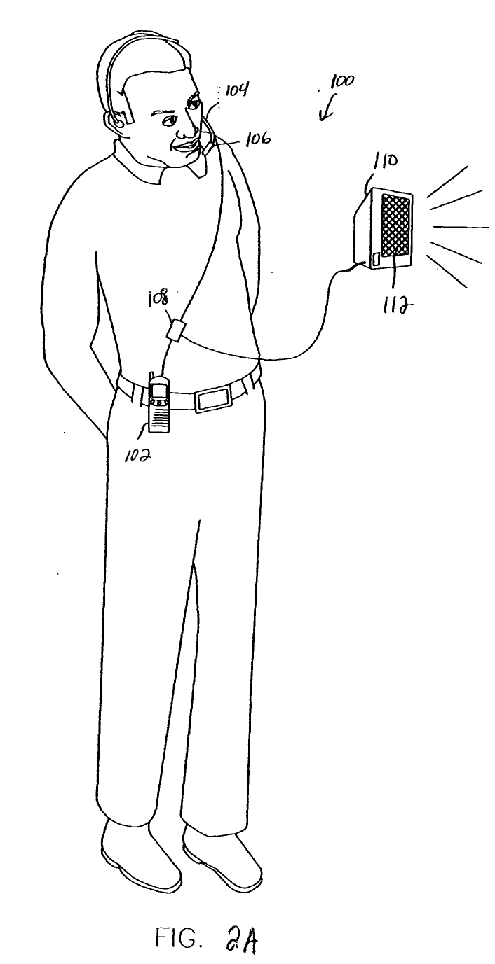

Referring now to the drawings and initially to FIGS. 1A & 1B, work environments are shown generally at 10, 20. FIGS. 1A & 1B illustrate communications devices with sound masking systems 12, 22 in accordance with first and second embodiments of the present invention. The work environments 10, 20 shown are an open office environment. However, it should be recognized that the present invention is useful in other known work environments such as those using systems products. In addition, the present invention is also useful in environments other than work environments. In particular, the present invention is generally useful in any situation where the user of a communications device desires to have a measure of privacy when having a conversation. Accordingly, the present invention is useful in any public or private area where a generally private conversation is desired.

As shown in FIGS. 1A & 1B, the work environment 10 includes conventional office furniture or equipment, such as a chair 22 and a desk 24. The second work environment 20 also includes a chair 26 and a desk 28. The first work environment 10 includes a communications device and sound masking system 12 in accordance with a first embodiment of the invention. The communications device and sound masking system 12 include a conventional telephone 30, and a voice or sound masking system 32. The voice masking system 32 includes the speakers 34. Likewise, the second environment 20 also includes a conventional telephone 38 and a voice masking system 40 that includes a speaker 42. The voice masking systems 32, 40 include logic designed to generate a voice masking signal in order to mask the speech of the user in the work environments 10, 20, respectively.

In the illustrated embodiments, the voice masking systems 32, 40 includes an interface having logic operable to produce the voice masking signal. The interface is located in the speakers 34, 42, in the illustrated embodiments, thereby allowing the present invention to be used with a conventional telephone. However, the interface of the present invention may also be incorporated directly into a telephone or other communications device thereby allowing the use of a conventional speaker. In addition, the associated telephone could be connected to a local computer. The logic operable to create the voice masking signal would be resident in the computer in order to create the voice masking signal and project it with associated speakers. Also, it should recognized that the logic operable to create the voice making signal may be resident in hardware, software or both.

As will be more thoroughly explained below, the voice masking systems 32, 40 generate a voice masking signal in substantially real-time that is at least partially derived from the voice sounds of the user of the respective workspace environments 10, 20. The speakers 34 or speaker 42 should be set in generally close proximity to the user and directed to project the voice or sound masking signal away from the user of the communications device and towards the general area of others in the space. The voice masking signal interferes with the ability of others, such as users of adjacent workspaces, from readily discerning the voice sounds. As used herein, the phrase “not readily discernable” means that although portions of the speech will be heard and the identity of the speaker may be recognized, the average worker will not be able to readily comprehend the meaning of what is being said.

The voice masking signal generated by the voice masking systems 32, 40 is emitted by speakers placed in close proximity to the origination of sound and directed towards the general area of others in the space. For example, the signal generated by the voice masking system 32 in the first works environment 10 is emitted by the speakers 34. Likewise, the signal generated by the voice masking system 40 in the second work environment 20 may be emitted by the speaker 42. It should be noted that the speaker 42 is connected via a wireless connection to the telephone 38. Also, it should be recognized that the speakers 34 or the speaker 42 may be placed in various other locations in a particular work environment in addition to those illustrated in the figures. Further, additional speakers in the work environment could also be implemented with the present invention.

The first and second work environments may also include feedback sensors for providing feedback to the voice masking systems 32, 40 respectively. The feedback sensors may measure volume or ambient noise to assist the voice masking systems 32, 40 in generating an appropriate masking signal.

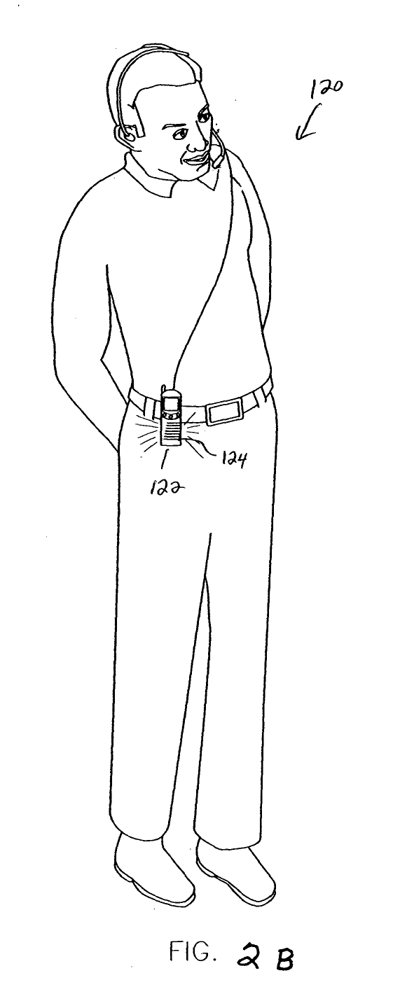

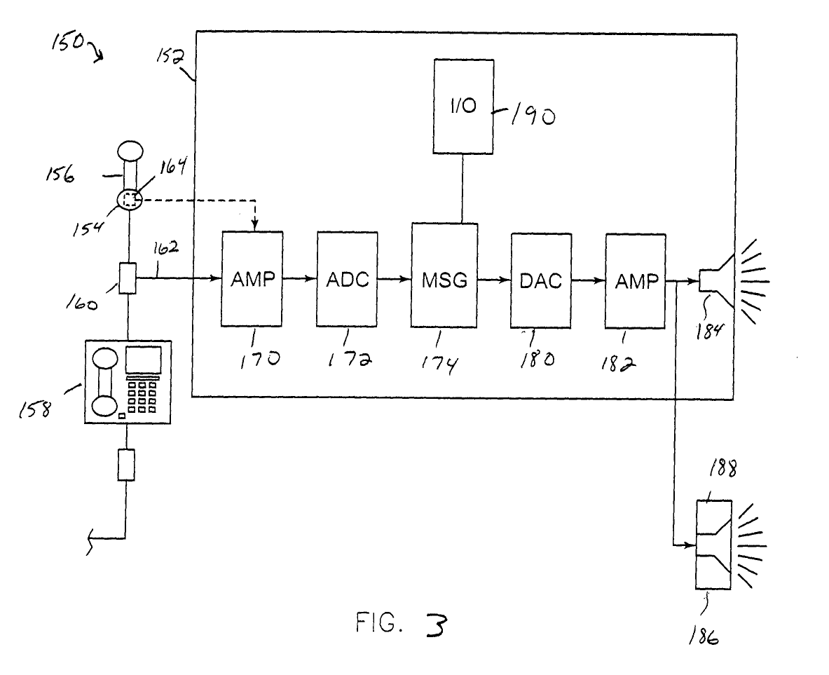

FIG. 2A illustrates an alternate embodiment of a voice masking system according to the invention. The voice masking system 100 is adapted for use with a cellular telephone 102, and particularly for use with a hands-free headset 104. The hands-free headset includes a microphone 106 that receives the inputted signal, i.e., the voice sounds of a user. A splitter connector 108 divides the input signal and sends it to the signal generating unit 110. The signal generating unit 110 generates a voice masking signal in substantially real-time and emits the masking signal using a speaker 112. Those skilled in the art will recognize that the masking system is not limited to telephones, but may also be used with other communication equipment, such as radios. Also, it should be recognized that a hands-free headset is not necessary. A user could the cellular telephone 102 with the microphone from the cellular telephone 102 used to receive the voice sounds of the user. The input signal would be modified as described herein with the voice masking signal emitted from the speaker 112. The speaker 112 could also be connected to the body of the user, e.g. the belt, in order to mobile with the user.

FIG. 2B illustrates another embodiment of a voice masking system for use with communication equipment. The voice masking system 120 includes a cellular telephone 122 that includes an integrated speaker 124. The cellular telephone 122 includes an internal voice masking system (not shown) that generates a masking signal to be emitted by the speaker 124.

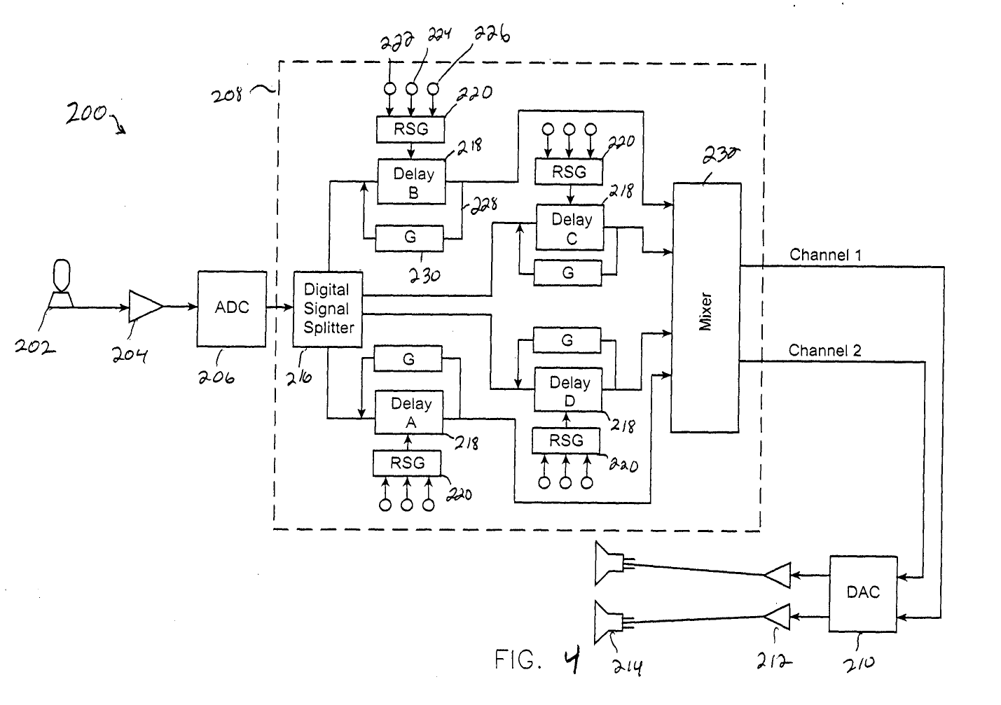

Turning now to FIG. 3, a voice masking system according to one aspect of the invention is shown generally at 150. The voice masking system 150 includes a signal generating unit 152 which receives a signal representative of a voice sound from a microphone 154. As shown in FIG. 3, the microphone 154 is a telephone microphone from a telephone handset 156 associated with a telephone base 158. The signal from the microphone 154 is divided by splitter connector 160, which sends the signal input 162 to the signal generating unit 152. In alternate embodiments, an external microphone 164 may be used, such as an external voice coil pickup device. Suitable pickup devices include the Radio Shack Telephone Handset Recording Control #42-1237 and Radio Shack telephone Listener #43-231B. It should be recognized by those of ordinary skill in the art that the pickup device may need modifications such as the reversal of some wiring in order to properly feed the input signal of the voice sounds to the signal generating unit. In still further embodiments, the microphone 168 of a hands-free speaker phone may be used as the microphone for inputting voice sounds. Furthermore, those skilled in the art will recognize that a microphone that is independent of the use of a telephone may also be completely used with the system.

The signal input 162 is first sent to an amplifier 170, and then converted to a digital signal by an analog-to-digital converter 172. A masking signal generator 174 then applies an algorithm to the digital signal to convert the signal to a masking signal, as will be explained below. The masking signal is then converted to an analog signal by the digital-to-analog converter 180 and then amplified by an amplifier 182. The masking signal is then emitted by a speaker 184 that is integrated with the signal generating unit 152, and/or by an external speaker 186. The external speaker 186 may be a stand alone speaker, or may be attached with or housed within a barrier member or support member 188. The signal generating unit 152 also may include one or more input/output devices 190, such as volume controls, feedback sensors, and the like, to assist in controlling the voice masking system 150.

In one embodiment, the masking signal generator includes one or more processors, such as a microprocessor and a digital signal processor. In an alternate embodiment the voice masking system may include a plurality of signal delay buffers to convert the digital signal to a masking signal using time varying delays.

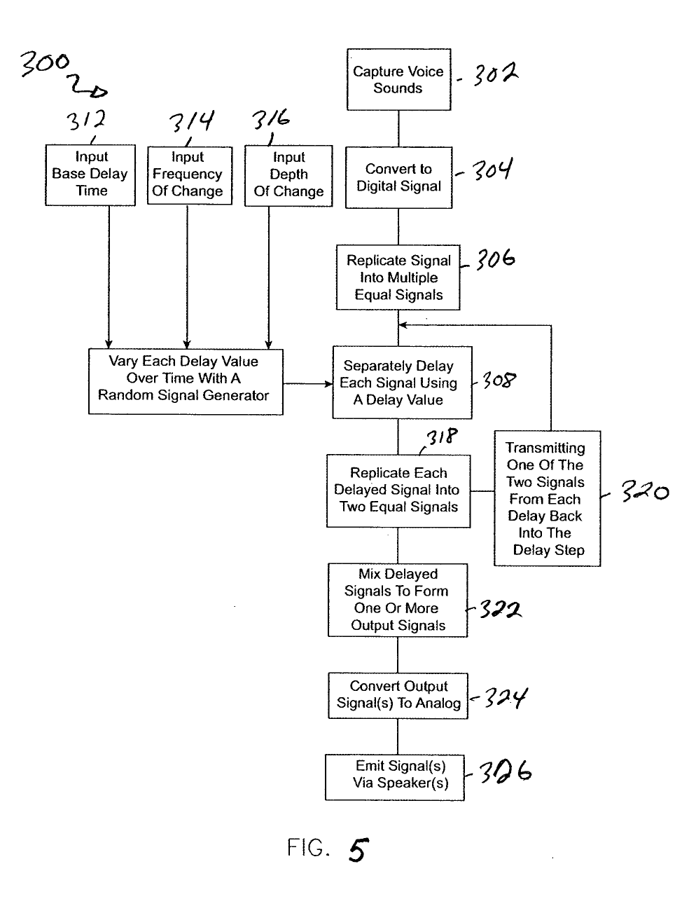

FIG. 4 illustrates a voice masking system 200 that utilizes delay buffers. The system 200 includes an input device 202, an amplifier 204, an analog-to-digital converter 206, and a masking signal generator 208, a digital-to-analog converter 210, a plurality of amplifiers 212, and a plurality of speakers 214. The masking signal generator 208 includes digital signal splitter 216 that replicates the digital signal to create multiple equal signals. Each of the replicated signals is transmitted to an individual signal delay buffer 218. Each signal delay buffer 218 is connected to a separate random signal generator 220 that modulates the delay of the buffer by a time varying function using a pseudo-random number generator. Each random signal generator has a set of variables to control the modulation of the delay. The variables are controlled by base delay time adjuster 222, a frequency of change adjuster 224, and the maximum depth of change adjuster 226. The base delay time adjuster 222 sets the seed value for the pseudo-random number generator. The frequency of change adjuster 224 sets the time interval between the generation of new delay values. The maximum depth of change adjuster 226 sets the largest deviation that is allowed from the base delay time.

The delayed signal output from a signal delay buffer 218 is replicated into two equal signals using an output digital signal splitter (not shown). One of the delayed output signals is returned through a feedback loop 228 to the signal delay buffer 218 to amplify the delay. The feedback loop includes a gain circuit 230 having an adjustable gain value. The second delayed output signal is transmitted to a mixer 232. The delayed output signals from each of the signal delay buffers 218 are mixed by the mixer 232 to produce the masking signal. The masking signal includes one or more components that correspond to different combinations of delayed output signals.

In operation, when the masking signal is output by a speaker, the time varying delays create the effect of several different people talking at once. Specifically, mixing two delayed sounds together creates the effect of an echo. Adding more than two delays creates a repeating echo sound or the illusion of multiple simultaneous voices. Moreover, as each delay varies over time, the pitch of the delayed sound changes due to the Doppler effect. The random Doppler pitch shifts introduced by varying the delays for the signal delay buffers 218 using the random signal generators 220 randomly shifts the pitch of the speech represented by the input signal, causing a distortion of the speech that sounds as though different people are talking. In addition, the gain circuit 230 in the feedback loop 228 for each signal delay buffer 218 amplifies the delayed signal from the signal delay buffer to create a decaying echo effect. This ensures that the voice masking system 200 does not have a discernible delay at the beginning of a talker's speech or an un-masked signal at the end of the speech. Preferably, the gain value is about 30 percent, although it should be understood that this value is meant to be illustrative, rather than limiting. Other gain values would also work depending on the desired decaying echo effect.

FIG. 5 illustrates a method for generating a masking signal according to another embodiment of the invention. The method 300 includes the capturing (at 302) of a voice sound, such as through a microphone. The voice sound is then converted (at 304) to a digital signal via analog-to-digital converter. The signal is then replicated (at 306) into multiple equal signals. Each of the multiple signals is separately delayed (at 308) using a delay value. The delay value is supplied by a random signal generator that varies (at 310) the delay value over time. The random signal generator varies the delay value according to inputted variables, including the base time delay (at 312), the frequency of change (at 314), and the depth of change (at 316).

After each of the signals is delayed (at 310), each delayed signal is replicated (at 318) into two signals, one of which is transmitted (at 320) back to the delay step. The other of the two delayed signals is mixed (at 322) with the other delayed signal to form one or more output signals. The output signals are converted (at 324) to analog and then emitted (at 326) by a speaker.

Although the invention has been described and illustrated with reference to specific illustrative embodiments thereof, it is not intended that the invention be limited to those illustrative embodiments. For example, while the embodiments of the invention shown were generally directed to open office environments, it should be appreciated that the voice masking system could also be applied to public meeting spaces and private offices. Therefore, those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

I claim:

1. A communications device with a sound masking system comprising:
a communications device having an audio input device adapted to capture a voice sound of a user;
a voice masking signal generator in communication with the audio input device and adapted to generate a masking signal capable of interfering with the ability of others in the area of the communications device to readily discern the voice sound of the user, the masking signal being at least partially derived from the voice sounds; and
at least one speaker in communication with the masking signal generator, the at least one speaker adapted to emit the masking signal.

2. The system of claim 1, wherein the audio input device comprises a telephone microphone.

3. The system of claim 2, wherein the telephone is a wireless telephone.

4. The system of claim 3, wherein the audio input device comprises a hands-free headset.

5. The system of claim 1, wherein the masking signal comprises re-mixed portions of the inputted voice sounds.

6. The system of claim 1, wherein the masking signal comprises time-delayed portions of the inputted voice sounds.

7. The system of claim 1, wherein the masking signal comprises portions of the inputted voice sounds mixed with other sounds.

8. The system of claim 1, wherein the at least one speaker is located in an office environment.

9. The system of claim 1, wherein the at least one speaker is in communication with the masking signal generator via a wireless connection.

10. A communications device with a voice masking system for use in a work environment, comprising:
a communications device with an audio input device adapted to receive and transmit a voice sound of a user;
a voice masking system capable of generating and emitting an audible voice masking signal based on a user's voice as detected by the audio input device of the communications device, the voice masking signal adapted to prevent others in the area of the user from readily discerning the voice sounds of the user; and
at least one speaker for emitting the voice making signal.

11. The communications device with a voice masking system of claim 10, wherein the workspace comprises an open office environment.

12. The work environment of claim 10, wherein the communications device is a telephone.

13. The work environment of claim 10, wherein the communications device is a radio.

14. The work environment of claim 13, wherein the voice masking signal is generated by re-mixing portions of the voice sounds of the user.

15. The work environment of claim 12, wherein the speaker is connected to the telephone as a one piece element.

16. A method for masking the voice of a user, the method comprising: capturing a voice sound of a user with an audio input device; generating a masking signal derived at least in part from the captured voice sounds, the masking signal capable of interfering with the ability of other users of the work environment to readily discern the voice sounds; and emitting the masking signal into at least a portion of an area of the user.

17. The method of claim 16, wherein the voice sounds are captured while the user is speaking on a telephone.

18. The method of claim 17, wherein the masking signal is generated by re-mixing portions of the voice sounds.

19. The method of claim 18, wherein the masking signal is generated by time-delaying portions of the voice sounds.

20. The method of claim 19, wherein the masking signal is generated by mixing portions of the voice sounds with other sounds.

21. The method of claim 20, wherein the masking signal is generated in substantially real-time.
